(19) United States
(12) Patent Application Publication
(10) Pub. No.: US 2018/0038996 A1
(43) Pub. Date: Feb. 8, 2018

(54) MITIGATION OF SCREEN DOOR EFFECT IN HEAD-MOUNTED DISPLAYS

(71) Applicant: VALVE CORPORATION, Bellevue, WA (US)

(72) Inventor: Joshua Hudman, Bellevue, WA (US)

(73) Assignee: VALVE CORPORATION, Bellevue, WA (US)

(21) Appl. No.: 15/666,341

(22) Filed: Aug. 1, 2017

Related U.S. Application Data
(60) Provisional application No. 62/370,119, filed on Aug. 2, 2016.

(51) Int. Cl. G02B 3/00

(52) U.S. Cl. CPC G02B 3/0056

(57) ABSTRACT

Methods and apparatus are provided for displaying an image to a viewer, for example in a head-mounted display (HMD) application, with reduced visual artifacts such as screen-door effect. A phase optic is disposed between the HMD lens and the user's eye. The optic changes the distribution of the light so the user's eye cannot focus the light better than the sub-pixel distance. The user can therefore not resolve the sub-pixel structure, and the structure therefore appears as one larger pixel, mitigating the screen-door effect. A significant reduction in screen-door effect visual artifacts arising from the periodic structure of the display panel may therefore be obtained.

This application claims the benefit of Provisional Application Ser. No. 62/370,119, filed on Aug. 2, 2016, the contents of which are herein incorporated by reference in their entirety for all purposes.

### BACKGROUND OF THE DISCLOSURE

### 1. Field of the Disclosure

The disclosure relates generally to displays, and more specifically to methods and systems for mitigating visual artifacts such as the screen door effect in applications such as head-mounted virtual reality displays.

### 2. General Background

One current generation of virtual reality (“VR”) experiences are created using head-mounted displays (“HMDs”), which can be tethered to a stationary computer (such as a personal computer (“PC”), laptop, or game console), combined and/or integrated with a smart phone and/or its associated display, or self-contained. VR experiences generally aim to be immersive and disconnect the users' senses from their surroundings.

Generally, HMDs are display devices, worn on the head of a user, that have a small display device in front of one (monocular HMD) or each eye (binocular HMD). A binocular HMD has the potential to display a different image to each eye. This capability can be used to display stereoscopic images.

A typical HMD has either one or two small displays with lenses and semi-transparent (i.e., “hot”) mirrors embedded in a helmet, eyeglasses (also known as data glasses) or visor. The display units are typically miniaturized and may include CRT, LCD, Liquid crystal on Silicon (LCoS), or OLED technologies. Such display system sometimes exhibit undesirable and distracting visual artifacts in the display output that have nothing to do with the information desired to be presented.

The screen-door effect (“SDE”) is one such undesired visual artifact that is associated with display devices and systems, where the fine lines (typically orthogonally arranged) separating pixels (or subpixels) on a display device become visible in the displayed image. To reduce or mitigate this artifact, various optical methods to eliminate the visibility of the spaces between the pixels have been developed, as ordinarily skilled artisans will recognize.

Attempts to minimize screen-door effect have involved using smaller pixels and providing diffuser screens or anti-glare films on the display output, among other techniques. However, there continues to be a need for reducing the screen-door effect, including in head-mounted display applications.

### BRIEF DESCRIPTION OF THE DRAWINGS

By way of example, reference will now be made to the accompanying drawings, which are not to scale.

FIG. 1 depicts a system (100) for mitigating screen-door effect visual artifacts in HMD applications according to certain embodiments of the present invention.

FIG. 2 depicts a portion of the top view of a rectangular microlens array (200) that may be incorporated into certain embodiments of the present invention.

### DETAILED DESCRIPTION

Those of ordinary skill in the art will realize that the following description of the present invention is illustrative only and not in any way limiting. Other embodiments of the invention will readily suggest themselves to such skilled persons, having the benefit of this disclosure. Reference will now be made in detail to specific implementations of the present invention as illustrated in the accompanying drawings. The same reference numbers will be used throughout the drawings and the following description to refer to the same or like parts.

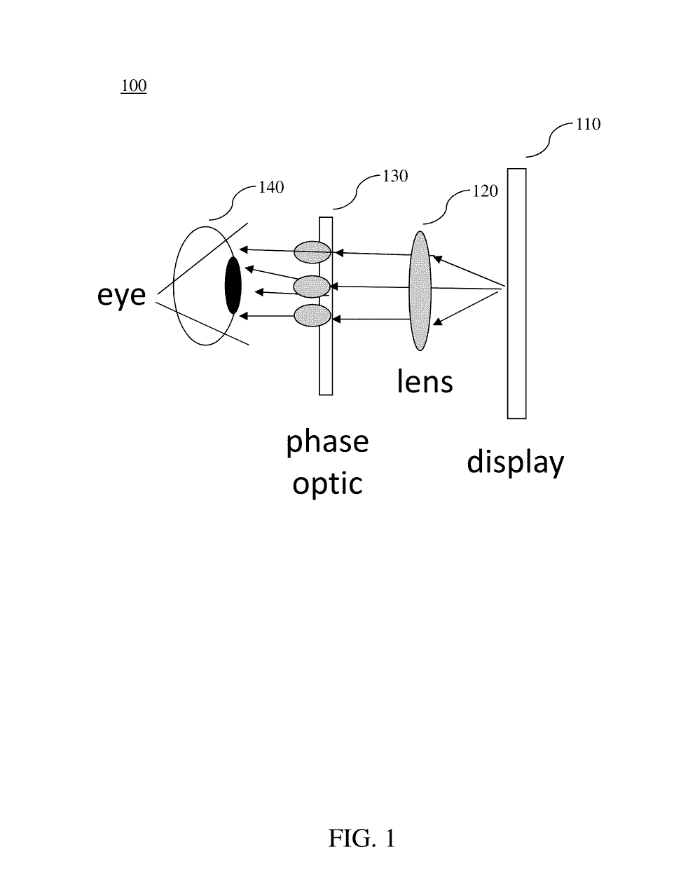

FIG. 1 depicts a system (100) for mitigating screen-door effect visual artifacts in HMD applications according to certain embodiments of the present invention. As depicted in FIG. 1, light emanating from display 110 passes through a lens 120 (i.e., the objective lens) and then through a phase optic 130 before entering a user's eye 140. The region to the left of lens 120 (i.e., between the lens and the user's eye) is known as collimated space, and this is the region where phase optic 130 is located.

In contrast with prior art techniques to mitigate screen-door effect visual artifacts, which in some cases implement some sort of optical filter between the objective lens 120 and the display 110, certain embodiments of the present invention implement phase optic 130 in the collimated space between the lens 120 and the user's eye 140. Such placement of phase optic 130 is neither taught nor suggested by the prior art, nor does it produce predictable results. Indeed, ordinarily skilled artisans will recognize that placing a phase optic such as item 130 in the collimated space would be considered to be a counter-intuitive technique for mitigating screen-door effect visual artifacts.

In certain embodiments for use in HMD applications, the resolution of display 110 as shown in FIG. 1 is 1200×1000 pixels, and the field of view is approximately 110 degrees.

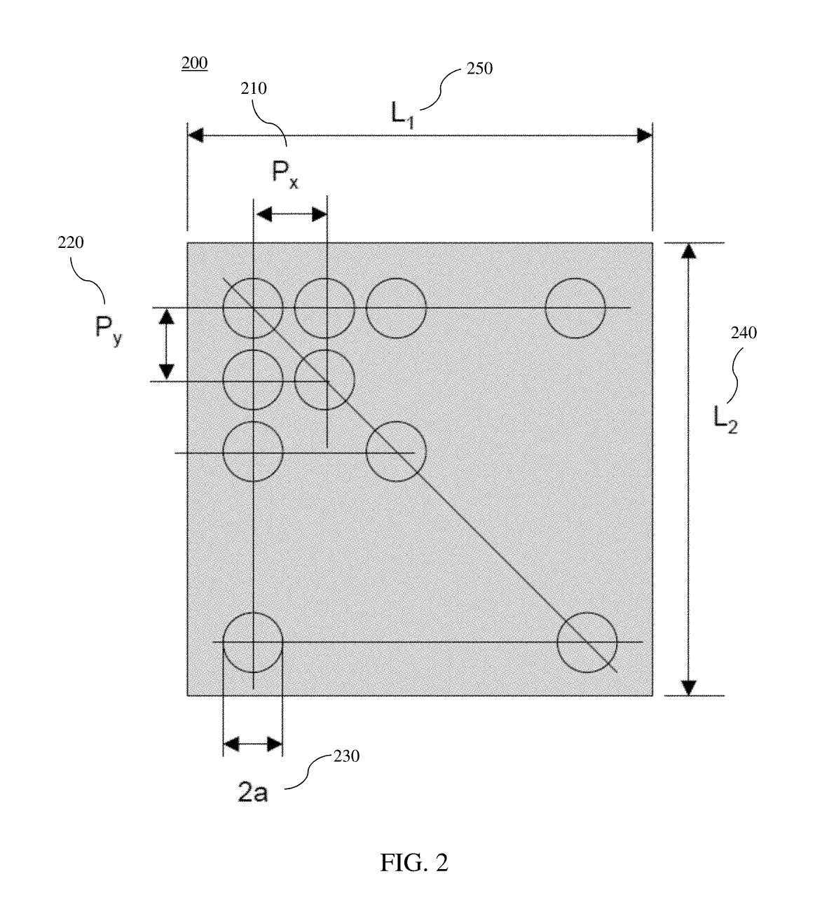

In certain embodiments of the present invention that are optimized for use in such HMD applications, phase optic 130 as shown in FIG. 1 comprises a microlens array. FIG. 2 depicts a portion of the top view of a rectangular microlens array 200 that may be incorporated into certain embodiments of the present invention. As shown in FIG. 2, the microlens array can be characterized by a pitch in either the x (210) or y (220) direction (i.e., Pₓ and P_{y}), and by the radius of curvature for each microlens in the array. As used herein, pitch refers to the shortest distance between the optical axis of two neighboring microlenses. In certain embodiments of the present invention, phase optic 130 as shown in FIG. 1 comprises a microlens array having 0.6 mm pitch (in two orthogonal directions) between microlenses and a radius of curvature of 85 mm for each microlens.

Depending on the requirements of each particular implementation, phase optic 130 may comprise Poly(methyl methacrylate) (“PMMA”) or polycarbonate materials, and may comprise an anti-reflective (“AR”) coating.

As previously noted, FIG. 2 depicts a rectangular microlens array 200. Depending on the requirements of each particular implementation, the microlens array may be implemented as a hexagonal array, a circular (“bull's eye”) array, or any other suitable pattern, as ordinarily skilled artisans will readily recognize.

Thus, by including a phase altering optic element in the collimated space between the lens and the user's eye in HMD applications mitigates the undesirable screen-door effect often visible on displays (e.g., OLED panels) in HMD applications.

This, in certain embodiments, an optic adds the proper phase function so as to decrease the angular resolution to match the red-green-blue (“RGB”) pixel resolution over the eye box of interest. Preferably, in such embodiments, the decrease in angular resolution must be discontinuous from one pixel to the next, over the full eye box. The decrease in resolution can only occur over one pixel and cannot contagiously spread to the next pixel such that eye accommodation can correct the angular spread due to the phase function. The angular spread caused by the microlens is used to lower the modulation transfer function (“MTF”) of the HMD lens just enough so that subpixels cannot be resolved. This is done by balancing the f/# of the microlens array causing a discrete blurring over a narrow bandwidth of spatial frequency and over a small sub-aperture region in the pupil so that eye accommodation cannot correct the blurring. The previously mentioned embodiments satisfy these conditions.

Many modifications and other embodiments of the invention will come to mind of one skilled in the art having the benefit of the teachings presented in the forgoing descriptions and the associated drawings. Therefore, it is understood that the invention is not to be limited to the specific embodiments disclosed, and that modifications and embodiments are intended to be included as readily appreciated by those skilled in the art.

While the above description contains many specifics and certain exemplary embodiments have been described and shown in the accompanying drawings, it is to be understood that such embodiments are merely illustrative of and not restrictive on the broad invention, and that this invention not be limited to the specific constructions and arrangements shown and described, since various other modifications may occur to those ordinarily skilled in the art, as mentioned above. The invention includes any combination or sub-combination of the elements from the different species and/or embodiments disclosed herein.

We claim:

1. An apparatus for mitigating screen-door effect visual artifacts in head-mounted displays, comprising a phase optic located in the collimated space between a HMD focusing lens and a user's eye.

2. The apparatus of claim 1, wherein said phase optic comprises a microlens array.

3. The apparatus of claim 2, wherein said microlens array has a pitch of 0.6 mm in two orthogonal dimensions and a radius of curvature of 85 mm for each lens in said microlens array.

4. The apparatus of claim 2, wherein said microlens array is a rectangular array.

5. The apparatus of claim 3, wherein said microlens array is a rectangular array.

6. The apparatus of claim 2, wherein said microlens array is a hexagonal array.

7. The apparatus of claim 3, wherein said microlens array is a hexagonal array.

8. The apparatus of claim 2, wherein said microlens array is a circular array.

9. The apparatus of claim 3, wherein said microlens array is a circular array.
